(19) United States
(12) Patent Application Publication
(10) Pub. No.: US 2003/0177342 A1
(43) Pub. Date: Sep. 18, 2003

(54) Processor with register dirty bits and special save multiple/return instructions

(75) Inventor: Toshiyasu Morita, Redwood City, CA (US)

Correspondence Address: SQUIRE, SANDERS & DEMPSEY L.L.P, 600 HANSEN WAY, PALO ALTO, CA, 94304-1043, US

(73) Assignee: Hitachi Semiconductor (America) Inc., San Jose, CA

(21) Appl. No.: 10/099,268

(22) Filed: Mar. 15, 2002

(51) Int. Cl. G06F 9/00

(52) U.S. Cl. 712/228

(57) ABSTRACT

The processor has a set of registers with each register having a dirty bit. The processor executes a method comprising: determining if a register used by a first function has a set dirty bit; and if the dirty bit is set: pushing data from the register to a stack; clearing the dirty bit; storing a bitmask in the stack indicating the register from which data was pushed; and restoring data to the register from the stack after execution of a second function that used the register.

### TECHNICAL FIELD

This invention relates generally to processors, and more particularly, but not exclusively, provides a processing having register dirty bits.

### BACKGROUND

A processor is a machine for executing sequential series of instructions. These instructions read data and create temporary results that may be used later in the sequence of processing. These temporary results are kept in fast storage areas called “registers”.

A processor also executes “function calls” to perform small tasks which are repetitively performed and/or shared across different types of processing. Each function requires registers to perform processing, and as there is only one set of registers, so some sort of protocol must be followed by the called function so it does not destroy the called function's intermediate results. This protocol is called a “calling convention”.

A calling convention typically includes two items: the list of registers which are “callee preserved” and the list of registers which are “callee destroyed”. The callee-preserved registers are the registers whose values must be preserved by the called function. Either the called function may opt not to use the registers, or else the called function may use them but is required to save the contents before processing and restore the result after processing thereby preserving the original contents of the register.

The callee destroyed registers are registers that the called function may use without saving the original contents. If the caller generates temporary data which must be preserved in the callee destroyed registers, then it is the responsibility of the caller function to save the data before calling another function, and also to restore the data after the called function has returned.

This designation of each register as either callee-preserved or callee-destroyed is inefficient because each function performs a different type of processing. Some functions may require a large number of callee-preserved registers to hold intermediate results while calling other functions, whereas some functions may require a large number of callee-destroyed registers to perform complex calculations without saving and restoring registers to the stack.

Register dirty bits, as in U.S. Pat. No. 6,205,543, are used for speeding up multitasking. The dirty bits are used to record which registers have been used by a current program and therefore, when a second program is used, only modified registers (as indicated by the dirty bits) are saved. However, this is limited to multitasking and occur at a rate of only 20 to 40 times per second. In contrast, function calls may occur tens of thousands of times per seconds.

### SUMMARY

The present invention enables a processor to utilize its registers more efficiently by eliminating the need to designate each register as either callee-preserved or callee-destroyed. The invention provides a processor feature that enables the called function to determine at runtime which registers are used by the calling function, and to only save the registers which actually hold values used by the calling function. This is desirable because it enables a compiler to use the registers more efficiently for processing data and also reduces memory bandwidth used when calling and returning from functions.

A processor, in accordance with an embodiment of the invention, has a set of registers, wherein each register is augmented with an extra bit designated as the “dirty” bit. The dirty bit for each register may be set depending on the implementation. In a hardware-controlled implementation, the dirty bit is set whenever the register is loaded. This includes but is not limited to register-to-register moves, memory-to-register movies, and arithmetic operations where the register is the destination. In a software-controlled implementation, the dirty bit is set manually via an instruction hereby designated MARKD for “mark dirty”.

The processor further comprises an instruction set for use with the registers. The instruction set includes a PUSHD instruction for selectively pushing registers depending on the status of its dirty bit and a RETD instruction, which is a return instruction which pops a bitfield from the stack. The RETD instruction checks each bit in the bitfield, and if it is set, it restores the corresponding register from the stack and sets its dirty bit. If the bit in the bitfield is clear, it only clears the register's corresponding dirty bit. Note that this instruction must check the bits in the reverse order as the save multiple dirty instruction so the registers will be restored in the correct order.

The present invention also provides a method for a processor to utilize its registers more efficiently during function calls. The method comprises: determining which registers have set dirty bits; saving data in the registers having set dirty bits; storing a bitmask indicating which registers have been stored; calling a second function; and restoring the registers having saved data after the second function executes.

Accordingly, the present invention provides a processor and associated method for utilizing the processor's registers more efficiently.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1A is a block diagram illustrating a computer according an embodiment of the invention;

FIG. 1B is a block diagram illustrating a register set with dirty bits according to an embodiment of the invention;

FIG. 2 is a block diagram illustrating a hardware implementation using “dirty-bit-set-on-write;”

FIG. 3 is a block diagram illustrating a software implementation using a MARKD instruction;

FIG. 4A is a block diagram illustrating execution of a PUSHD instruction when a dirty bit is not set;

FIG. 4B is a block diagram illustrating execution of a PUSHD instruction when a dirty bit is set;

FIG. 5 is a block diagram illustrating execution of a PUSHD instruction for multiple registers when only a subset of the registers have a set dirty bit;

FIG. 6 is a block diagram illustrating execution of a RETD instruction;

FIG. 7 is a block diagram illustrating register use overlap;

FIG. 8 is a block diagram illustrating execution of PUSHD and RETD instructions with multiple functions; and

FIG. 9 is a flowchart illustrating a method for efficiently using registers according to an embodiment of the invention.

### DETAILED DESCRIPTION OF THE ILLUSTRATED EMBODIMENTS

The following description is provided to enable any person skilled in the art to make and use the invention, and is provided in the context of a particular application and its requirements. Various modifications to the embodiments will be readily apparent to those skilled in the art, and the principles defined herein may be applied to other embodiments and applications without departing from the spirit and scope of the invention. Thus, the present invention is not intended to be limited to the embodiments shown, but is to be accorded the widest scope consistent with the principles, features and teachings disclosed herein.

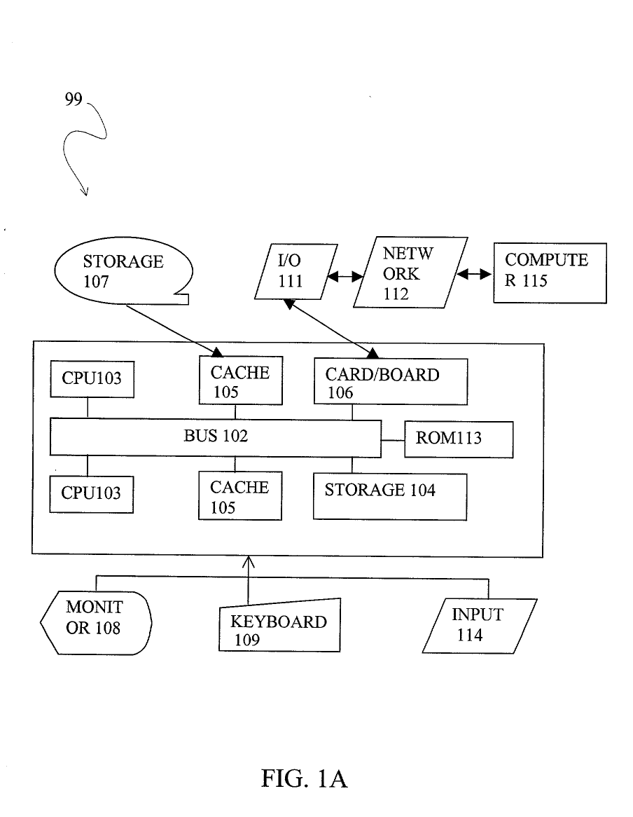

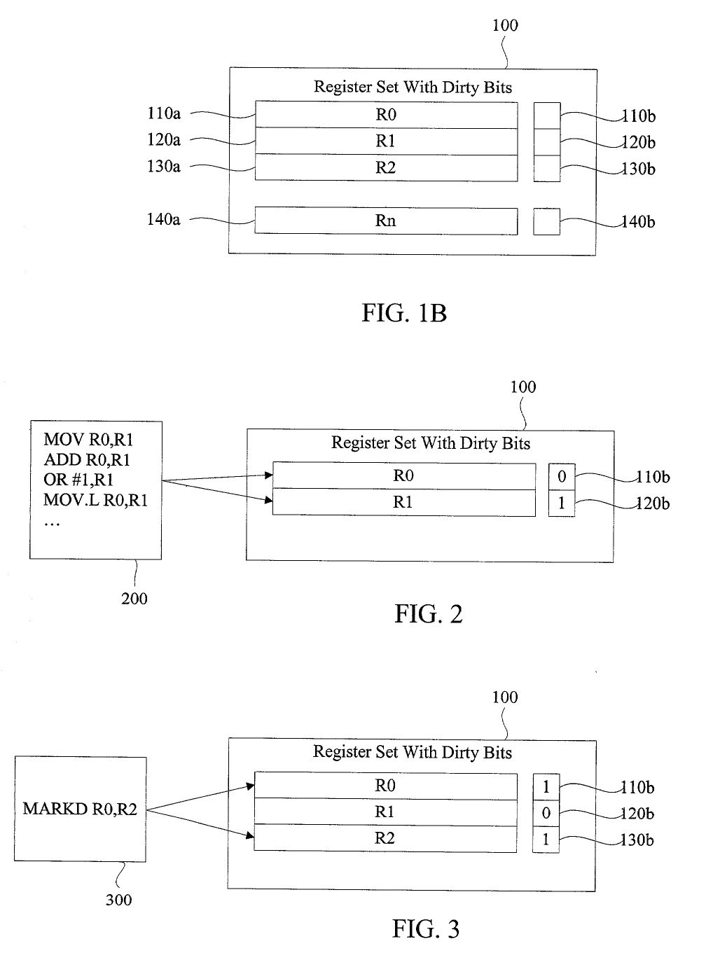

FIG. 1A illustrates a computer system 99, as an embodiment according to the present embodiment. Well-known structures and devices are shown in block diagram form in order to avoid unnecessarily obscuring the present embodiment. A computer 99 includes: a bus 102 for communicating information among one or more processors 103 (for example: micro-, mini-, super-, super scalar-, multi-, out-of-order- processors); main memory storage 104, such as a random access memory (RAM) or other dynamic storage device, coupled to the bus 102 for storing information and instructions to be executed and used by the processors 103; and a cache memory 105, which may be on a single chip with one or more of the processors (e.g. CPUs) 103 and coupled with the bus 102. The storage 104 and one or more cache memories 105 are used for storing temporary variables in registers, or for storing other intermediate information during execution of instructions by the processors 103. The storage 104 and/or the peripheral storage 107 and/or the firmware ROM 113 are examples of computer readable media physically implementing the method and used for storing the program or code embodiment. Also, the method of the embodiment may be implemented by hardware on a card or board. The hardware, software and media used to implement the embodiment may be distributed on the network 112 to another computer 115.

The peripheral storage 107 may be a magnetic disk or optical disk, having computer readable media. The computer readable media may contain code/data, which, when run on a general purpose computer, constitutes the embodiment code modifier and thereby provides an embodiment special purpose computer. A display 108 (such as a cathode ray tube (CRT) or liquid crystal display (LCD) or plasma display), an input device 109 (such as a keyboard, mouse, VUI, and any other input) 114 are coupled to the computer 101. An input/output port (I/O) 111 couples the computer with other structure, for example with the network 112 (a LAN, WAN, WWW, or the like), to which is coupled another similar computer system 115.

The I/O 111 provides two-way data communication coupling to the network 112. The I/O may be a digital subscriber line (DSL) card or modem, an integrated services digital network (ISDN) card, a cable modem, a telephone modem, a cable, a wire, or a wireless link to send and receive electrical, electromagnetic, or optical signals that carry digital data streams representing various types of information, including instruction sequences. The communication may include a Universal Serial Bus (USB), a PCMCIA (Personal Computer Memory Card International Association) interface, etc. One of such signals may be a signal implementing the present invention.

FIG. 1B is a block diagram illustrating a register set 100 with dirty bits according to an embodiment of the invention. Register set 100 includes n registers R0, R1, R2-Rn. Each register R0, R1, R2-Rn includes, respectively, fields 110a, 120a, 130a and 140a for storing data. Each register R0, R1, R2-Rn also includes, respectively, dirty bits 110b, 120b, 130b and 140b. The dirty bits 110b-140b may each be 1 bit in length. In an alternative embodiment of the invention, registers in register set 100 include an additional register for storing dirty bits instead of each register having a dirty bit.

In a hardware implementation, as will be discussed in further detail in conjunct with FIG. 2, the dirty bits 110b-140b are set whenever a corresponding register is loaded. In a software implementation, the dirty bits are set manually, as will be discussed in further detail in conjunction with FIG. 3.

FIG. 2 is a block diagram illustrating a hardware implementation using “dirty-bit-set-on-write.” In a hardware implementation, the dirty bit will always be set when a register is loaded. This includes but is not limited to register-to-register moves, memory-to-register movies, and arithmetic operations where the register is the destination. For example, implementing instructions 200 modifies the R1 register, so the hardware automatically sets its dirty bit 120b. The dirty bit 110b of R0 is unchanged.

FIG. 3 is a block diagram illustrating a software implementation using a MARKD instruction. In a software-controlled implementation, the dirty bit is set manually via an instruction hereby designated MARKD for “mark dirty.” This instruction accepts either a bitmask of registers: MARKD R0,R1,R3,R3,R5 or MARKD R0-R3, R5 or strictly a range of registers: MARKD R0-R2. For example, using a MARKD R0,R2 instruction 300 in FIG. 3, dirty bits 110b and 130b of R0 and R2 respectively are set. As register R1 is not modified, its dirty bit 120b is not set.

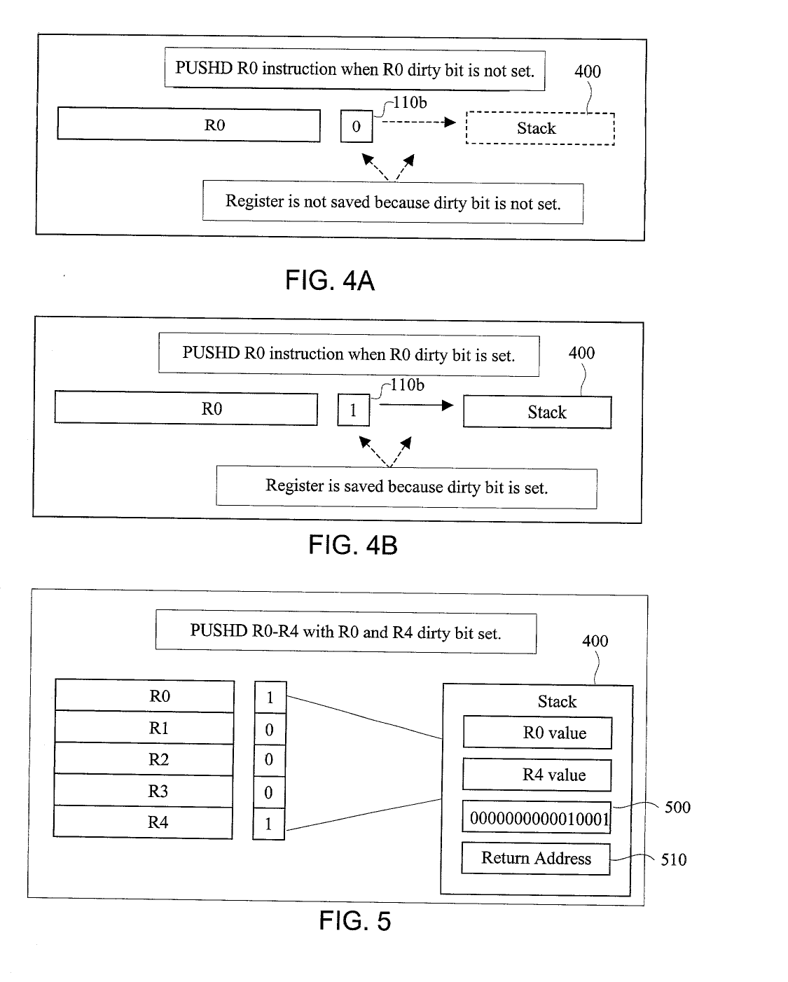

FIG. 4A is a block diagram illustrating execution of a PUSHD instruction when a dirty bit is not set. PUSHD is an instruction that selectively pushes registers depending on the status of its dirty bit. This instruction can either accept a bitmask of registers: PUSHD R0-R6, R8-R9 or a range of registers: PUSHD R0-R9.

The PUSHD instruction will check each register designated in the operand, and if the register's corresponding dirty bit is set, it will save the register to stack 400 and clear the dirty bit. For example, in FIG. 4A, register R0 is not saved because its corresponding dirty bit 110b is not set.

FIG. 4B is a block diagram illustrating execution of a PUSHD instruction when a dirty bit is set. In comparison to FIG. 4A, register R0 will be saved to stack 400 since its dirty bit 110b is set. In addition, the PUSHD instruction also stores a bitmask indicating which registers have been stored to stack 400.

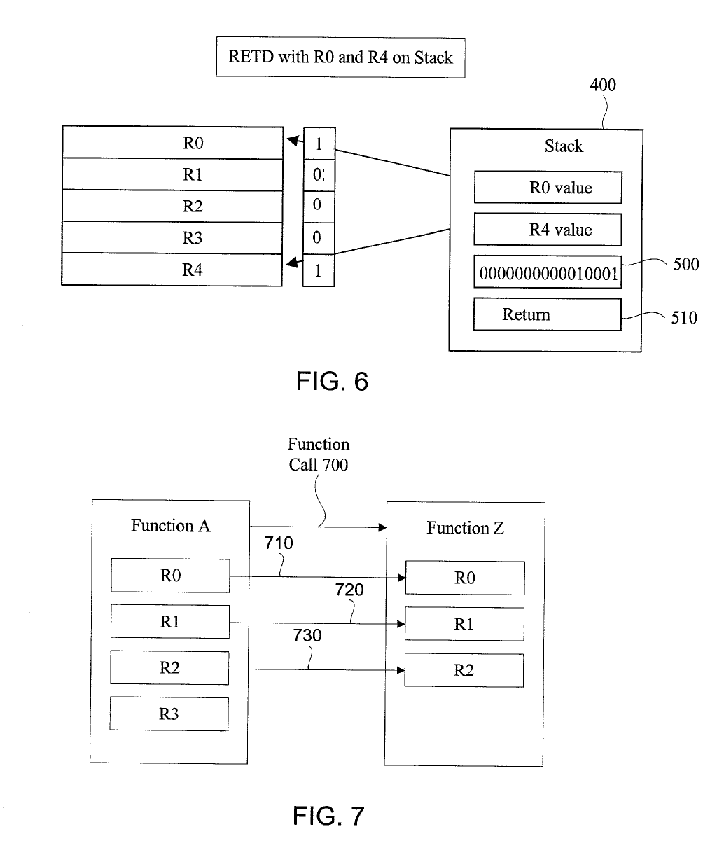

FIG. 5 is a block diagram illustrating execution of a PUSHD instruction for multiple registers when only a subset of the registers have a set dirty bit. In the example of FIG. 5, a PUSHD R0-R4 instruction is issued. The R0 register is pushed first because its corresponding dirty bit is set. After pushing, the R0 dirty bit is cleared. Next, the R4 register is pushed because its dirty bit is set. After pushing, the R4 dirty bit is cleared. Lastly, a bitmask 500 indicating saved registers is pushed LAST on stack 400 (bits 0 and 4 SET indicating R0 and R4). A return address 520 is pushed later after a function call, as will be discussed further in conjunction with FIG. 6.

FIG. 6 is a block diagram illustrating execution of a RETD instruction. A RETD instruction is a return instruction that pops a bitmask from the stack 400. It checks each bit in the bitmask 500, and if it is set, it restores the corresponding register from the stack and sets its dirty bit. If the bit in the bitmask is clear, it only clears the register's corresponding dirty bit. Note that this instruction must check the bits in the reverse order so that the registers will be restored in the correct order.

In the example of FIG. 6, a return address 510 is popped from stack 400. Next, bitmask 500 indicating saved registers is popped from stack (bits 0 and 4 SET indicating registers R0 and R4). Next, R4 is popped first because bit 4 is set bitmask 500. R4's dirty bit is also set. R0 is popped because bit 0 is set in bitmask 500. R0's dirty bit is then also set.

FIG. 7 is a block diagram illustrating register use overlap. In the example of FIG. 7, function A calls function Z. Function A uses some of the registers of register set 100 and Function Z also uses some of the same registers as function A. Obviously, this requires that function Z save each register used by function A since their usage patterns overlap.

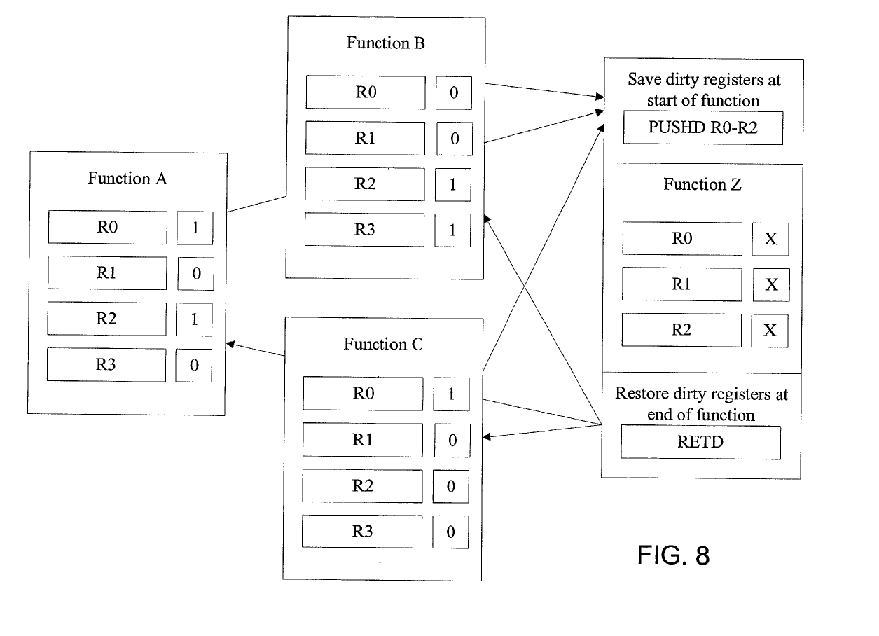

FIG. 8 is a block diagram illustrating execution of PUSHD and RETD instructions with multiple functions to overcome register use overlap problems. Using the register dirty bit plus PUSHD and RETD instructions to enables the called function to save and restore only the registers that are used by the caller. In the example of FIG. 8, when Function A calls Function Z, only registers R0 and R2 are saved using the PUSHD instruction and restored using the RETD instruction by Function Z. When Function B calls Function Z, only registers R2 and R3 are saved using the PUSHD instruction and restored using the RETD instruction by Function Z. When Function C calls Function Z, only register R0 is saved using the PUSHD instruction and restored using the RETD instruction by Function Z.

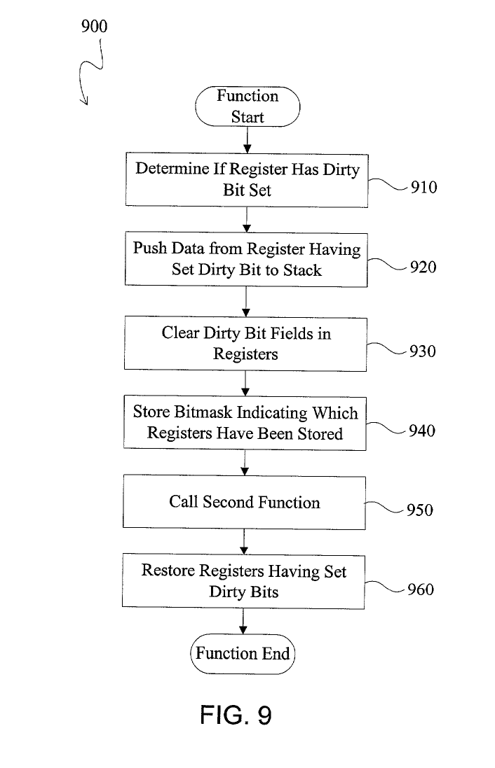

FIG. 9 is a flowchart illustrating a method 900 for efficiently using registers according to an embodiment of the invention. First, using a PUSHD instruction, all specified registers are examined to determine (910) if their respective dirty bits are set. For the registers having set dirty bits, the data from these registers are pushed (920) to a stack. The registers dirty bits are then cleared (930). Afterwards, a bitmask is stored (940) in the stack indicating which registers were pushed. The second function is then called (950). After the second function has completed, the registers are restored (960) according to the bitmask and data stored in the stack. The method then ends.

The foregoing description of the illustrated embodiments of the present invention is by way of example only, and other variations and modifications of the above-described embodiments and methods are possible in light of the foregoing teaching. For example, a separate register may be used for storing dirty bits in place of each register having a dirty bit. The embodiments described herein are not intended to be exhaustive or limiting. The present invention is limited only by the following claims.

What is claimed is:

1. A method, comprising:
determining if a register used by a first function has a set dirty bit; and
if the dirty bit is set
pushing data from the register to a stack,
clearing the dirty bit,
storing a bitmask in the stack indicating the register from which data was pushed, and
restoring data to the register from the stack after execution of a second function that used the register.

2. The method of claim 1, wherein the determining, pushing, clearing, storing and restoring are repeated for all registers that are used by both the first and second functions.

3. The method of claim 1, wherein the restoring comprises:
popping data from the stack to the register; and
setting the dirty bit of the register.

4. The method of claim 1, wherein the determining, pushing, clearing and storing is performed upon receipt of a PUSHD instruction.

5. The method of claim 1, wherein the restoring is done upon receipt of a RETD instruction.

6. The method of claim 1, wherein the dirty bit is in the register.

7. The method of claim 1, wherein the dirty bit is in a second register capable to store dirty bits for a plurality of registers.

8. The method of claim 1, further comprising setting the dirty bit of the register whenever the register is loaded.

9. The method of claim 1, further comprising setting the dirty bit of the register manually.

10. A processor, comprising:
a register set, each register having a dirty bit to indicate if a corresponding register has been used by a function;
the processor capable to execute a set of instructions, the instructions including a PUSHD instruction for pushing data from a register having a set dirty bit and a RETD instruction for restoring data to the register.

11. The processor of claim 10, where in the PUSHD instruction causes the processor to execute a method, the method comprising:
determining if a register used by a first function has a set dirty bit; and
if the dirty bit is set
pushing data from the register to a stack,
clearing the dirty bit, and
storing a bitmask in the stack indicating the register from which data was pushed.

12. The processor of claim 11, wherein the RETD instruction causes the processor to execute a second method, the second method comprising:
popping data from the stack to the register; and
setting the dirty bit corresponding to the register.

13. The processor of claim 10, wherein the processor sets the dirty bit of the register whenever the register is loaded or modified.

14. The processor of claim 10, wherein the processor sets the dirty bit(s) of the register(s) whenever a MARKD instruction is executed.

15. A processor, comprising:
a register set, the register set including a dirty bit register capable to store dirty bits for other registers in the register set, the dirty bits indicating if a corresponding function has been used by a function;
the processor capable to execute a set of instructions, the instructions including a PUSHD instruction for pushing data from a register having a set dirty bit and a RETD instruction for restoring data to the register.

16. The processor of claim 15, wherein the PUSHD instruction causes the processor to execute a method, the method comprising:
determining if a register used by a first function has a set dirty bit in the dirty bit register; and
if the dirty bit is set
pushing data from the register to a stack,
clearing the dirty bit, and
storing a bitmask in the stack indicating the register from which data was pushed.

17. The processor of claim 16, wherein the RETD instruction causes the processor to execute a second method, the second method comprising:
popping data from the stack to the register; and
setting the dirty bit of the dirty bit register corresponding to the register.

18. The processor of claim 14, wherein the processor sets a dirty bit in the dirty bit register corresponding to a register whenever the register is loaded.

19. The processor of claim 14, wherein the processor sets a dirty bit in the dirty bit register corresponding to a register whenever a MARKD instruction is executed.
